(19) United States
(12) Patent Application Publication
(10) Pub. No.: US 2018/0126816 A1
(43) Pub. Date: May 10, 2018

(54) SPRING SEAT RUBBER

(71) Applicant: HONDA MOTOR CO., LTD., Tokyo (JP)

(72) Inventors: Yohei KONDO, Wako-shi (JP); Hisashi ISHIMATSU, Wako-shi (JP)

(21) Appl. No.: 15/798,777

(22) Filed: Oct. 31, 2017

(30) Foreign Application Priority Data
Nov. 4, 2016 (JP) 2016-215961

(51) Int. Cl. B60G 11/16

(52) U.S. Cl. CPC B60G 11/16; B60G 15/062

(57) ABSTRACT

An upper spring seat rubber includes an elastic portion made of urethane and an insert ring contained in the elastic portion. The insert ring has a first extension portion extending between the sectional center of a coil spring and the upper spring seat in the radial direction of the upper spring seat rubber and a second extension portion extending between the sectional center of the coil spring and the upper spring seat in the axial direction of the upper spring seat rubber.

### BACKGROUND OF THE INVENTION

### 1. Field of the Invention

The present invention relates to a spring seat rubber interposed between a coil spring and a spring seat in a suspension device.

### 2. Description of the Related Art

For example, Japanese Patent No. 4,117,787 discloses a spring seat rubber disposed in a vehicle suspension device to prevent vibrations and noise from being transmitted to the vehicle body via a coil spring.

This spring seat rubber includes a hollow cylindrical portion and a flange that extends radially outward from an upper end portion of the cylindrical portion. The spring seat rubber is made of a rubber material such as a natural rubber, a butadiene rubber, a styrene-butadiene rubber, or a urethane rubber.

The spring seat rubber disclosed in Japanese Patent No. 4,117,787 is made only of a rubber material and is not reinforced at all. For this reason, when receiving a lateral force from the coil spring, the spring seat rubber allows the coil spring to largely displace in a direction orthogonal to the axial direction. This makes the load on the spring unstable, which may lower the vehicle's ride quality.

### SUMMARY OF THE INVENTION

The present invention has been made in view of the above point and has an object to provide a spring seat rubber that achieves improved rigidity to suppress the coil spring's displacement in the direction orthogonal to the axial direction when receiving a lateral force from the spring.

To achieve the above object, the present invention is a spring seat rubber interposed between a coil spring suspended in a suspension device and a spring seat that supports the coil spring, the spring seat rubber comprising: an elastic member made of urethane; and an insert member contained in the elastic member, wherein the insert member has a first extension portion extending between a sectional center of the coil spring and the spring seat in a radial direction of the spring seat rubber, and a second extension portion extending between the sectional center of the coil spring and the spring seat in an axial direction of the spring seat rubber.

The present invention can provide a spring seat rubber that achieves improved rigidity to suppress the coil spring's displacement in the direction orthogonal to the axial direction when receiving a lateral force from the spring.

### BRIEF DESCRIPTION OF THE DRAWINGS

FIG. 1 is a sectional view schematically illustrating the configuration of a suspension device incorporating a spring seat rubber according to an embodiment of the present invention.

FIG. 2 is an enlarged sectional view of an upper spring seat and an upper spring seat rubber.

FIG. 3 is a partially-exploded perspective view of an insert ring inserted in the upper spring seat rubber.

FIG. 4 is an enlarged sectional view of part A in FIG. 2.

FIG. 5A is a sectional view illustrating the configuration of an upper spring seat rubber according to a comparative example created by the present applicant, FIG. 5B is a distribution diagram of surface pressure applied to the upper spring seat rubber according to the comparative example, and FIG. 5C is a distribution diagram of surface pressure applied to the upper spring seat rubber according to the present embodiment.

FIG. 6 is an enlarged sectional view of an upper spring seat rubber and an upper spring seat to which a spring seat rubber according to a modification is applied.

FIG. 7 is an enlarged sectional view of part B in FIG. 6.

FIG. 8A is a partially-enlarged plan view of a lower spring seat rubber having a rib that stops a coil spring from rotating, and FIG. 8B is an enlarged sectional view taken along line VIII-VIII of FIG. 8A.

### DETAILED DESCRIPTION OF THE EMBODIMENTS

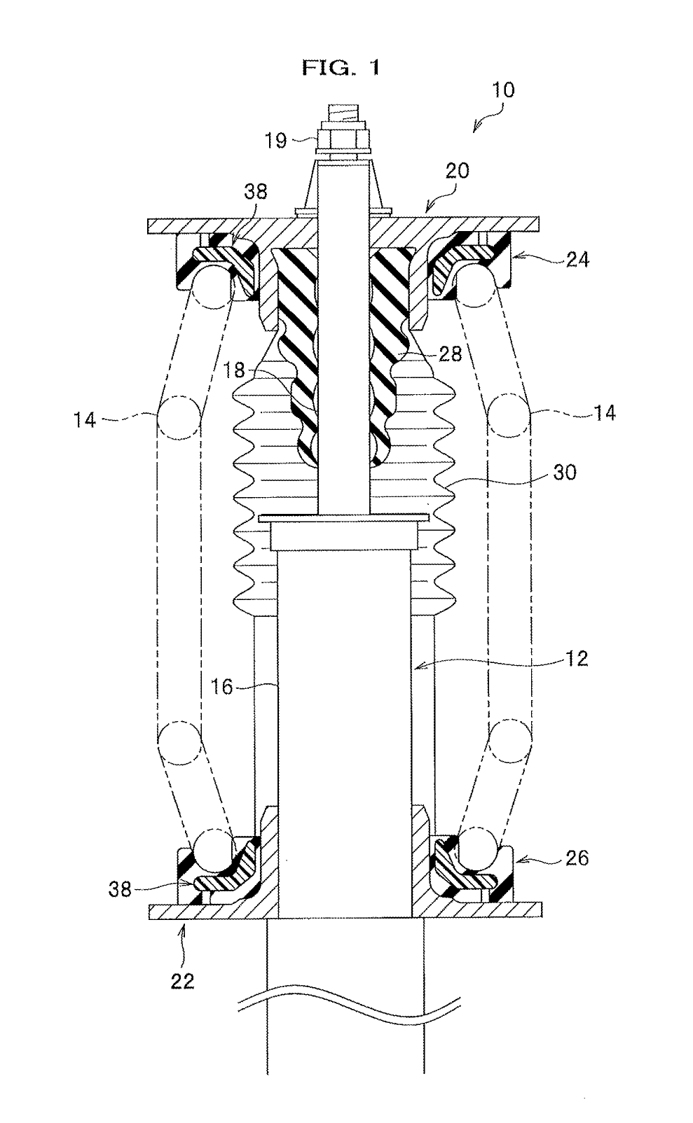

Next, an embodiment of the present invention is described in detail with reference to the drawings where necessary. FIG. 1 is a sectional view schematically illustrating the configuration of a suspension device incorporating a spring seat rubber according to the embodiment of the present invention.

As illustrated in FIG. 1, a suspension device 10 is connected to the wheel side (left and right rear wheels) via an attachment bracket (not shown). This suspension device 10 is configured including a shock absorber 12 connected to the vehicle body side via another attachment bracket (not shown) and a spiral coil spring (suspension spring) 14 suspended in the axial direction of the shock absorber 12.

Although the present embodiment illustrates a case where the coil spring 14 is suspended at the outer diameter side of the shock absorber 12 and substantially coaxially with the shock absorber 12, the present invention is not limited to this. The present invention also includes a case where, for example, the shock absorber 12 and the coil spring 14 are disposed separately side by side.

The shock absorber 12 includes an outer tube 16 formed of a hollow cylindrical body and a piston rod 18 whose upper portion is exposed to the outside from the outer tube 16. The upper end of the piston rod 18 is provided with a fastening nut 19 that screws onto a screw part.

As publicly known, the shock absorber 12 performs extension and compression actions to absorb, by use of the spring force exerted by the coil spring 14, an impact force that the vehicle receives from the road surface. When a piston (not shown) is displaced vertically following the extension and compression actions, a piston valve mechanism provided to the piston, a valve mechanism (not shown) provided to a cylinder (not shown), or the like produces damping force, serving to suppress the extension and compression actions.

The suspension device 10 also has an upper spring seat 20 disposed near an upper portion of the shock absorber 12 and a lower spring seat 22 disposed near a lower portion of the shock absorber 12. The coil spring 14 is suspended between the upper spring seat 20 and the lower spring seat 22. Although the present embodiment illustrates a case where a vehicle body frame (e.g., a rear side frame) to which the shock absorber 12 is attached and the upper spring seat 20 have separate structures, the present invention is not limited to this. For example, the upper spring seat 20 may be integral with the lower surface of the vehicle body frame.

The suspension device 10 further has an upper spring seat rubber (spring seat rubber) 24 which is supported by the upper spring seat 20 and retains an upper end portion (an end portion) of the coil spring 14 and a lower spring seat rubber (spring seat rubber) 26 supported by the lower spring seat 22 and retains a lower end portion (the other end portion) of the coil spring 14. Since the upper spring seat rubber 24 and the lower spring seat rubber 26 have substantially the same structure and disposed symmetrically, a description will be later given only of the upper spring seat rubber 24, and a description of the lower spring seat rubber 26 will be omitted.

The upper end portion (end turn) of the coil spring 14 is supported by the upper spring seat 20 via the upper spring seat rubber 24, and the lower end portion (end turn) of the coil spring 14 is supported by the lower spring seat 22 via the lower spring seat rubber 26.

Disposed below the upper spring seat 20 are a bump stop rubber 28 in engagement with the piston rod 18 and a dust cover 30 capable of extending and contracting in the axial direction of the piston rod 18 via a bellow portion thereof.

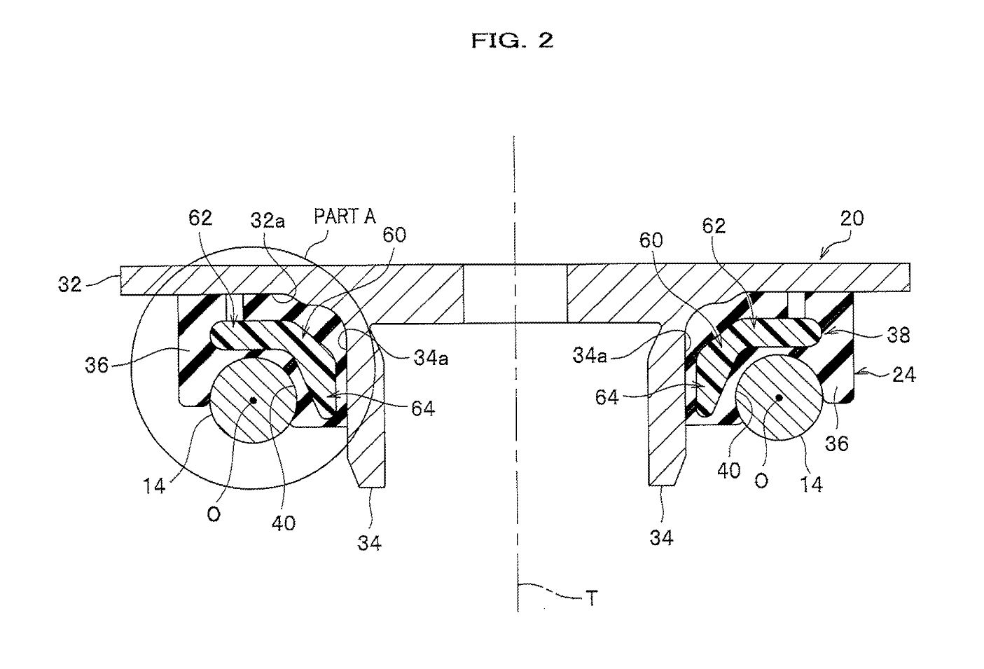

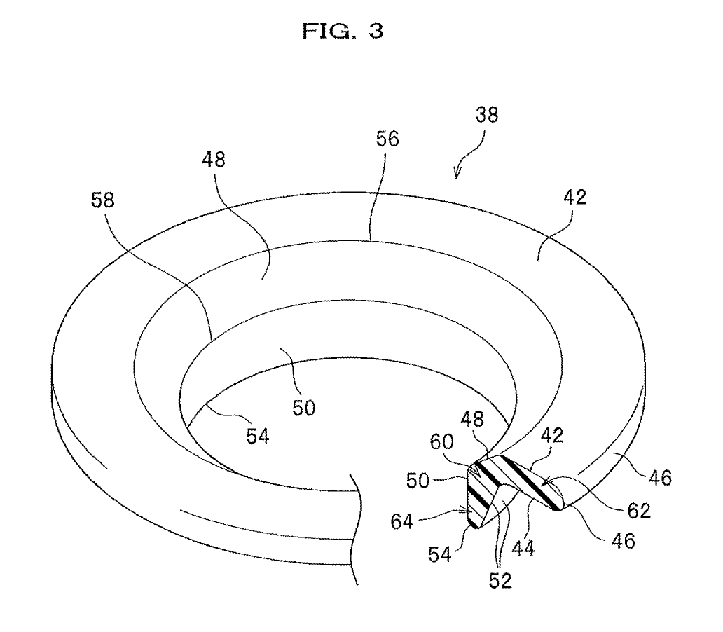

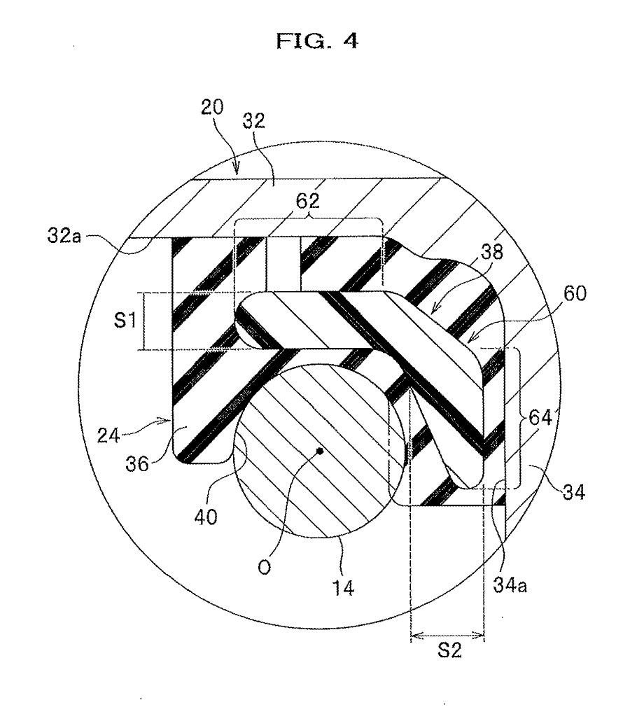

FIG. 2 is an enlarged sectional view of the upper spring seat and the upper spring seat rubber, FIG. 3 is a partially-exploded perspective view of an insert ring inserted in the upper spring seat rubber, and FIG. 4 is an enlarged sectional view of part A in FIG. 2.

The upper spring seat 20 is made of a metallic material, and includes a disc portion 32 and a tubular portion 34 that are integral with each other. The disc portion 32, which is located at an upper side, is formed in a disc shape with a flat upper surface. The tubular portion 34, which is located at a lower side, is formed in a substantially hollow cylindrical shape protruding downward (toward the shock absorber 12) from a lower surface 32a of the disc portion 32.

The upper spring seat rubber 24 includes an annular elastic portion 36 made of a urethane rubber and an annular insert ring 38 inserted in the elastic portion 36 by insert molding or the like. Note that the elastic portion 36 functions as an “elastic member made of urethane”, and the insert ring 38 functions as an “insert member contained in the elastic member”.

The elastic portion 36 is provided with a spring retention portion 40 which retains, with its inner circumferential surface, an upper end portion (end turn) of the coil spring 14, the upper end portion being part of the spiral coil of the coil spring 14. The spring retention portion 40 is formed with a curved surface which is arc-shaped in section.

As illustrated in FIG. 3, the insert ring 38 has an annular substantially-flat ring upper surface 42, an annular substantially-flat ring lower surface 44 opposite the ring upper surface 42, a chamfered circumferential edge surface 46 connecting the circumferential edge of the ring upper surface 42 and the circumferential edge of the ring lower surface 44, and a ring tapered surface 48 which is continuous with the inner diameter side of the ring upper surface 42 and gradually reduces its diameter toward the center.

The insert ring 38 further has a ring inner diameter surface which extends downward from the ring tapered surface 48 substantially coaxially, a ring outer diameter surface 52 which is continuous with the ring lower surface 44 and extends downward from the ring lower surface 44 with its outer diameter gradually reducing, and a ring lower edge curved surface 54 which connects the lower edge of the ring inner diameter surface 50 and the lower edge of the ring outer diameter surface 52 to each other. An annular first ridge line 56 is formed between the ring upper surface 42 and the ring tapered surface 48, and an annular second ridge line 58 is formed between the ring tapered surface 48 and the ring inner diameter surface 50.

The insert ring 38 is made of a resinous material and includes a ring main body 60, a first extension portion 62, and a second extension portion 64, which are integrally formed. Alternatively, the insert ring 38 may be made of a metallic material.

As illustrated in FIGS. 2 and 4, the first extension portion 62 extends between the sectional center O of the coil spring 14 and the lower surface 32a of the disc portion 32 of the upper spring seat 20 in the radial direction of the upper spring seat rubber 24. In other words, the first extension portion 62 is formed by the ring upper surface 42, the ring lower surface 44, and the circumferential edge surface 46, and extends substantially in parallel with the lower surface 32a of the disc portion 32 in a direction orthogonal to the axial direction of the upper spring seat rubber 24 (the direction of the axial line T).

As illustrated in FIGS. 2 and 4, the second extension portion 64 extends between the sectional center O of the coil spring 14 and an outer circumferential surface 34a of the tubular portion 34 of the upper spring seat 20 in the axial direction of the upper spring seat rubber 24 (the direction of the axial line T). In other words, the second extension portion 64 is formed by the ring inner diameter surface 50, the ring outer diameter surface 52, and the ring lower edge curved surface 54, and extends substantially in parallel with the axial line T.

Further, the second extension portion 64 extends in the direction of the axial line T, covering the sectional center O of the coil spring 14 to which a lateral force is to be applied. Meanwhile, the ring lower edge curved surface 54, which is located at the lowermost edge of the insert ring 38, is located past the sectional center O of the coil spring 14 in the direction of the axial line T.

As illustrated in FIG. 4, the maximum thickness S1 of the first extension portion 62 is smaller than the maximum thickness dimension S2 of the second extension portion 64 (S1<S2). Making the second extension portion 64 thicker than the first extension portion 62 enables enhancement of rigidity and strength against a lateral force and prevention of deformation. Further, making the first extension portion 62 thinner than the second extension portion 64 can contribute to the vertical extension and compression actions of the coil spring 14.

The suspension device 10 incorporating the spring seat rubber according to the present embodiment is basically configured as above, and its operation and advantageous effects are now described.

In the present embodiment, the insert ring 38 is inserted (contained) in the elastic portion 36 made of a urethane rubber. This insert ring 38 includes both of the first extension portion 62, which extends between the sectional center O of the coil spring 14 and the lower surface 32a of the disc portion 32 of the upper spring seat 20 in the radial direction of the upper spring seat rubber 24, and the second extension portion 64, which extends between the sectional center O of the coil spring 14 and the outer circumferential surface 34a of the tubular portion 34 of the upper spring seat 20 in the axial direction of the upper spring seat rubber (the direction of the axial line T).

When a urethane rubber is used as the upper spring seat rubber 24, setting the coil spring 14 to have a low dynamic spring constant makes it possible to prevent a surging-caused decrease in the vehicle ride quality (smooth ride region and road noise transmission performance) near the natural frequency of the coil spring 14 (a frequency of approximately 60 Hz). However, a urethane rubber has the property of being sensitive to hydrolysis, and water (liquid) absorbed into the urethane rubber may speed up aging, lowering durability.

Thus, in the present embodiment, if, for example, the urethane rubber as the elastic portion 36 absorbs water (liquid), the water (liquid) can be discharged when loads inputted from the coil spring 14 in vertical directions, vehicle front and rear directions, and left and right directions (vehicle width directions) are transmitted evenly to the upper spring seat rubber 24 via the first extension portion 62 and the second extension portion 64. Specifically, the water (liquid) can be discharged when loads in the left and right directions (the vehicle width directions) and the vehicle front and rear directions inputted from the coil spring 14 are transmitted via the first extension portion 62, and loads in the vertical directions and the vehicle front and rear directions are transmitted via the second extension portion 64.

As a result, the present embodiment can improve the performance of water (liquid) discharge from the elastic portion 36 made of a urethane rubber, and improve durability (water resistance) by suppressing hydrolysis (a chemical reaction where water reacts with a reactant, generating products of decomposition), which is a problem with a urethane rubber.

Further, when a urethane rubber is used as the upper spring seat rubber 24, input loads from the coil spring 14 may cause the end turn, in the direction orthogonal to the axial direction, of the coil spring 14 sitting on the urethane rubber to be displaced downward at the same time, which may decrease retention performance of the coil spring 14 against a lateral force. Further, when the spring constant of the upper spring seat rubber 24 itself is low, the upper spring seat rubber 24 is displaced to a large extend, and then, the terminal becomes slanted due to uneven surface pressure on the end turn of the coil spring 14, increasing the lateral force produced. As a result, the coil spring 14 is easily displaced in the direction orthogonal to the axial direction, which may lower steering stability.

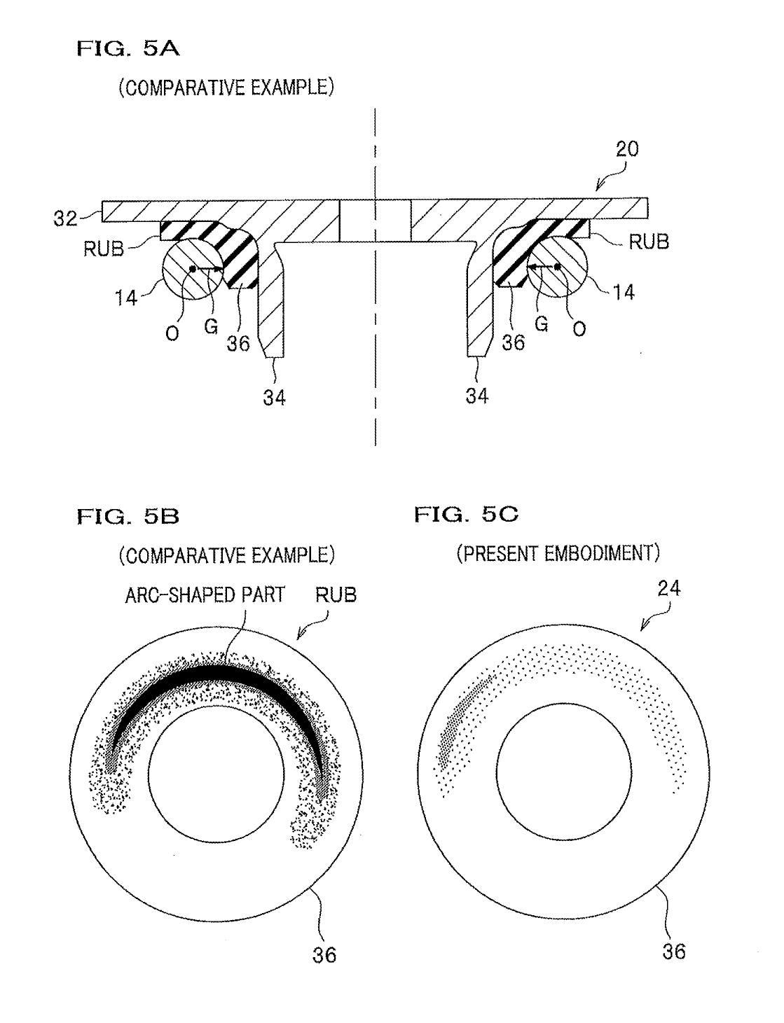

To prevent this, the present embodiment has such a structure that the second extension portion 64 of the insert ring 38 receives a lateral force from the coil spring 14, allowing reduction in its displacement in the direction orthogonal to the axial direction and thereby improvement in rigidity. In other words, by the insert ring 38 serving to function as a reinforcement member for the upper spring seat rubber 24, a displacement in the direction orthogonal to the axial direction is reduced, and in turn, rigidity can be improved. Further, since loads in the axial direction (the direction of the axial line T) are transmitted to the urethane rubber (the elastic portion 36) via the first extension portion 62 of the insert ring 38, surface pressure can be evened out (see FIG. 5C to be referred to later), enabling prevention of the end turn of the coil spring 14 from slanting due to uneven loads and thereby reduction in the lateral force produced by the coil spring 14. As a result, in the present embodiment, displacement in the direction orthogonal to the axial direction can be suppressed with the axial dynamic spring constant of the coil spring 14 remained low, achieving improvement in rigidity in the direction orthogonal to the axial direction and improvement in steering stability at the same time.

Further, in the present embodiment, the insert ring 38 inserted in the elastic portion 36 made of a urethane rubber can substantially even out the surface pressure applied to the urethane rubber with the surface pressure being low circumferentially. Thus, weakening of the urethane rubber and an increase in the dynamic spring constant due to foam crushing, which are problems with urethane rubbers, can be suppressed.

FIG. 5A is a sectional view illustrating the configuration of an upper spring seat rubber according to a comparative example created by the present applicant, FIG. 5B is a distribution diagram of surface pressure applied to the upper spring seat rubber according to the comparative example, and FIG. 5C is a distribution diagram of surface pressure applied to the upper spring seat rubber according to the present embodiment. The distribution diagrams of the surface pressure indicate the level of the applied surface pressure with the densities of dots: a portion in black with dense dots is a portion with high surface pressure, and a portion with loose dots is a portion with low surface pressure.

An upper spring seat rubber RUB according to the comparative example created by the present applicant is different from the present embodiment in being made only of a urethane rubber and having no insert ring 38 inserted therein.

As illustrated in FIG. 5B, in the comparative example, when a lateral force G is applied from the coil spring 14, the surface pressure is at its maximum in the black, arc-shaped portion at an upper location, and is low in the white portion at a lower location. In contrast, in the present embodiment, for the same lateral force G as that in the comparative example, the surface pressure is low and substantially evened out over the entire circumference as illustrated in FIG. 5C.

The present embodiment, in which the surface pressure applied by the coil spring 14 is low in the circumferential direction and substantially evened out, is advantageous in that even if the urethane rubber of the elastic portion 36 absorbs water (liquid), the water (liquid) can be discharged in all directions of the elastic portion 36, including vertical directions and radial directions, improving water discharge performance.

Further, although the present embodiment illustrates a case where the present invention is applied to both the upper spring seat rubber 24 and the lower spring seat rubber 26, the present invention is not limited to this. Improvement in rigidity in the direction orthogonal to the axial direction and improvement in steering stability can be achieved at the same time even when the present invention is applied to one of the upper spring seat rubber 24 and the lower spring seat rubber 26.

Next, a modification of the spring seat rubber is described below.

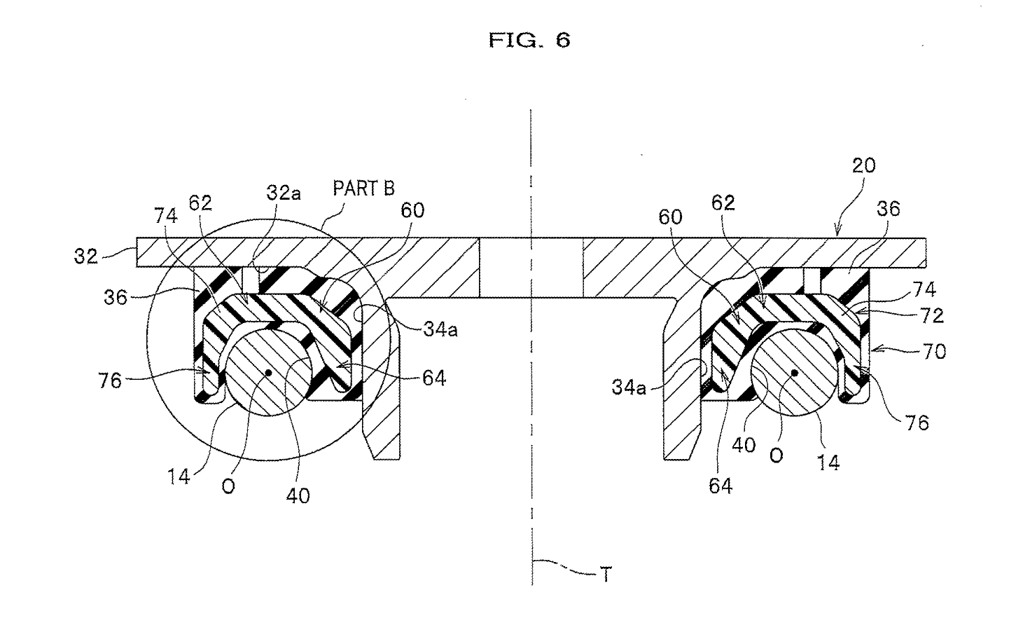

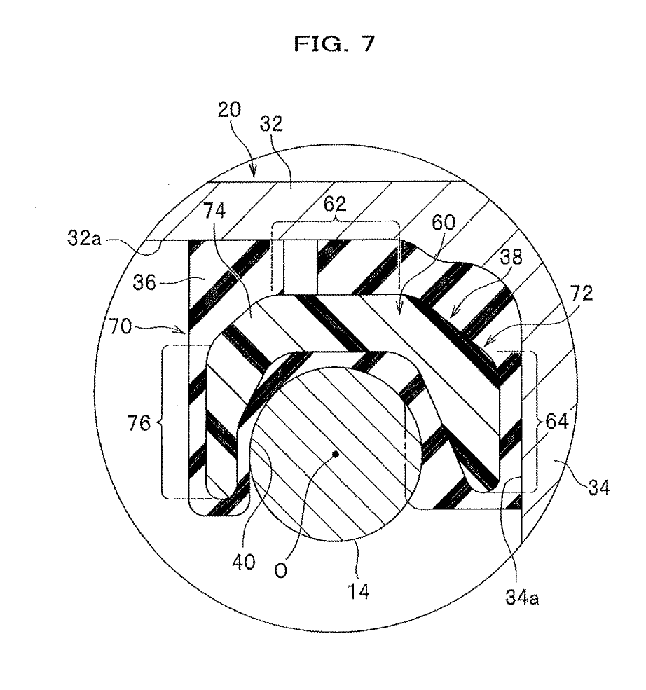

FIG. 6 is an enlarged sectional view of an upper spring seat rubber and an upper spring seat to which a spring seat rubber according to the modification is applied, and FIG. 7 is an enlarged sectional view of part B in FIG. 6. Note that the same elements as those of the configuration illustrated in FIGS. 1 to 5 are denoted by the same reference numerals as those assigned to them, and are not described in detail below.

As illustrated in FIGS. 6 and 7, an upper spring seat rubber 70 is different from the upper spring seat rubber 24 (see FIG. 2) in the sectional shape of an insert ring 72 inserted in the elastic portion 36. The insert ring 72 also has the first extension portion 62 and the second extension portion 64 illustrated in FIG. 2, but in addition to the first extension portion 62 and the second extension portion 64, further includes a third extension portion 76 which is continuous with a radially outer edge 74 of the first extension portion 62. The third extension portion 76 faces the second extension portion 64 substantially in parallel therewith with the sectional center O of the coil spring 14 in between (see FIG. 7).

Provided with the third extension portion 76, the insert ring 72 can also be situated at an outer side of the sectional center O of the coil spring 14, being able to receive loads inputted from a radially outer side. As a result, rigidity and strength can be improved even more.

Since the advantageous effects produced by the first extension portion 62 and the second extension portion 64 are the same as those described earlier, detailed descriptions are omitted.

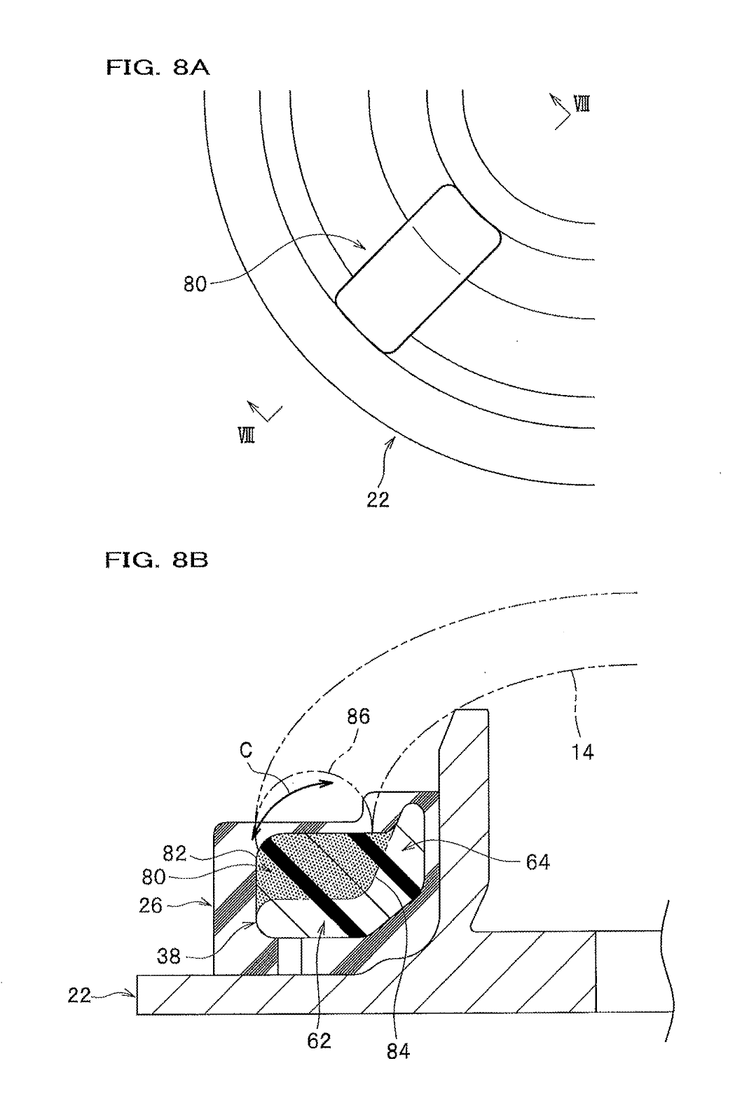

FIG. 8A is a partially enlarged plan view of a lower spring seat rubber having a rib that stops a coil spring from rotating, and FIG. 8B is an enlarged sectional view taken along line VIII-VIII of FIG. 8A. Although FIGS. 8A and 8B illustrate a case where a rib 80 is provided to the lower spring seat rubber 26 for convenience purposes, the rib 80 is provided to the upper spring seat rubber 24, as well.

The rib 80 is substantially rectangular in plan view (see FIG. 8A) and extends in the radial direction of the insert ring 38 (see FIG. 8B). The rib 80 is integrally molded with the insert ring 38 in such a manner as to protrude toward the coil spring 14. Further, the rib 80 is inserted in the elastic portion 36 by insert molding or the like. As illustrated in FIG. 8B, the rib 80 extends continuously from an outer diameter edge 82 of the first extension portion 62 to an outer surface 84 of the second extension portion (see the dotted portion).

When compressed, the coil spring 14 receives at its lower end portion (an end turn 86) a rotational force, and rotates. To prevent such rotation of the end turn 86 of the coil spring 14, rotation stop needs to be set. To this end, it is possible to provide a rotation-stop projection made of a rubber material such as a urethane rubber. However, a rotation-stop projection made of rubber is low in rigidity and strength, and may break.

Thus, in the present embodiment, the rib 80 is provided to the insert ring 38 to preferably avoid breakage of the rib 80 and improve rigidity and strength. Further, the provision of the rib 80 extending continuously from the outer diameter edge 82 of the first extension portion 62 to the outer surface 84 of the second extension portion 64 allows suppression of force applied to the first extension portion 62 and the second extension portion 64 in the opening direction of the insert ring 38 (the direction indicated by the arrow C in FIG. 8B), improving rigidity and strength. Furthermore, the provision of the rib 80 is advantageous in that axial variations in the spring loads can be reduced.

What is claimed is:

1. A spring seat rubber interposed between a coil spring suspended in a suspension device and a spring seat supporting the coil spring, the spring seat rubber comprising:
an elastic member made of urethane; and
an insert member contained in the elastic member, wherein
the insert member has
a first extension portion extending between a sectional center of the coil spring and the spring seat in a radial direction of the spring seat rubber, and
a second extension portion extending between the sectional center of the coil spring and the spring seat in an axial direction of the spring seat rubber.

2. The spring seat rubber according to claim 1, wherein
the insert member has a third extension member continuous with a radially outer edge of the first extension portion, and
the third extension portion faces the second extension portion with the sectional center of the coil spring in between.

3. The spring seat rubber according to claim 1, wherein
the spring seat rubber is both or either of an upper spring seat rubber supported by an upper spring seat and a lower spring seat rubber supported by a lower spring seat.

4. The spring seat rubber according to claim 2, wherein
the spring seat rubber is both or either of an upper spring seat rubber supported by an upper spring seat and a lower spring seat rubber supported by a lower spring seat.

5. The spring seat rubber according to claim 1, wherein
the insert member has a rim that protrudes toward the coil spring and stops the coil spring from rotating.

6. The spring seat rubber according to claim 2, wherein
the insert member has a rim that protrudes toward the coil spring and stops the coil spring from rotating.

7. The spring seat rubber according to claim 3, wherein
the insert member has a rim that protrudes toward the coil spring and stops the coil spring from rotating.

8. The spring seat rubber according to claim 4, wherein
the insert member has a rim that protrudes toward the coil spring and stops the coil spring from rotating.
